(19) United States
(12) Patent Application Publication
(10) Pub. No.: US 2026/0369218 A1
(43) Pub. Date: Nov. 19, 2026

(54) POWER-SAVING SIGNAL BUFFER FOR A PIXEL DRIVER CIRCUIT

(71) Applicant: GOOGLE LLC, Mountain View, CA (US)

(72) Inventors: Bo Li, Folsom, CA (US); Haritha Chanda, Fremont, CA (US)

(21) Appl. No.: 19/515,688

(22) PCT Filed: Oct. 1, 2024
(86) PCT No.: PCT/US2024/049396

§ 371 Date: Mar. 2, 2026

Related U.S. Application Data
(60) Provisional application No. 63/587,842, filed on Oct. 4, 2023.

(51) Int. Cl. G09G 3/32

(52) U.S. Cl. CPC G09G 3/32; G09G 2300/0814; G09G 2300/0842; G09G 2310/08; G09G 2330/023

(57) ABSTRACT

Power-saving signal buffers for pixel driver circuits are described herein. For example, one pixel driver circuit may include a first voltage rail configured to provide a first voltage, a second voltage rail configured to provide a second voltage, and a signal buffer component having a ground terminal and a power terminal. The first voltage may be greater than a ground voltage provided by a ground rail, while the second voltage may be greater than the first voltage provided by the first voltage rail. The ground terminal of the signal buffer component may be electrically coupled to the first voltage rail, rather than to the ground rail, while the power terminal may be electrically coupled to the second voltage rail. Corresponding display assemblies and devices using such pixel driver circuits are also disclosed.

### RELATED APPLICATIONS

This application claims priority to and the benefit of U.S. Provisional Application No. 63/587,842, filed on Oct. 4, 2023, the disclosure of which is hereby incorporated by reference in its entirety.

### BACKGROUND

Electric and electronic devices rely on electrical power that can be supplied from different types of sources and may be used with different levels of efficiency. While power efficiency is generally considered beneficial for any type of device, the consequences of inefficient or suboptimal power usage may vary from application to application. As one example, an appliance or electrical device such as a clothes dryer or vacuum cleaner may plug into an electrical outlet to access continuous and virtually unlimited power. Accordingly, while it may be generally advantageous for these types of devices to use power efficiently (e.g., to avoid high operational costs, to reduce unwanted heat, to minimize their environmental impact, etc.) there may be relatively little incentive for high-powered plug-in devices such as these to reduce every milliwatt of potential waste.

Conversely, smaller, portable devices such as smartphones or laptop computers tend to be more sensitive to power inefficiency since these tend to be used with battery power that, when it runs low or runs out altogether, limits the functionality and usefulness of the device. Accordingly, these types of devices may be designed with even more care and prioritization on power efficiency. Indeed, when it comes to portable, battery-powered devices, a long battery life combined with high-performance tends to be highly desired and popular in competitive marketplaces.

Still other electronic devices such as wearable and other ultra-portable devices may be more sensitive still to power inefficiency. For example, smart watches and rings, extended reality glasses, and/or other such devices generally have strict size and weight limits, making for significant physical constraints for any battery power they provide. As such, if these devices are not extremely judicious with their power usage, the battery life that the devices provide could be so short as to nearly make the devices unusable.

### SUMMARY

Power-sensitive display technologies that are also high performing in other important areas (e.g., being potentially very small in footprint while being capable of providing bright light with accurate color, etc.) are useful for a variety of applications, including the ultra-portable devices mentioned above (e.g., extended reality glasses, smart watches, etc.). One such technology involves pixel emitters implemented as micro light emitting diodes (microLEDs) that can each be driven by a power saving pixel driver circuit such as described herein. Along with other power-saving features, pixel driver circuits described herein include power-saving components such as power-saving signal buffers. Rather than being connected between a power rail and a ground rail in the standard way, power-saving signal buffers described herein may be connected between two power rails one with a higher voltage and one with a lower voltage. Connected like this, the signal buffers may still perform their desired function (e.g., buffering global, high-frequency pulse-width modulation (PWM) signals, etc.) while saving power in at least two ways. First, the voltage swing between the two power rails may be significantly less than the voltage swing between the upper power rail and a ground rail, leading to significantly less power consumption by the signal buffer itself as it rapidly charges and discharges a load. Second, the lower of the two power rails may be used to power other circuitry, such that the energy used by the signal buffer may be effectively recycled and used by other circuitry for other functions.

To this end, one implementation described herein involves a pixel driver circuit configured in accordance with principles described herein. The pixel driver circuit may include a first voltage rail configured to provide a first voltage, a second voltage rail configured to provide a second voltage, and a signal buffer, among other rails and electronic components. The first voltage provided by the first voltage rail may be greater than a ground voltage provided by a ground rail. The second voltage provided by the second voltage rail may be greater than the first voltage provided by the first voltage rail. The signal buffer may then have a ground terminal and a power terminal, the ground terminal being electrically coupled to the first voltage rail (rather than to the ground rail) and the power terminal being electrically coupled to the second voltage rail.

Other implementations described herein may involve a display assembly in accordance with principles described herein. Such a display assembly may include a plurality of pixel emitters, a display controller circuit, a plurality of pixel driver circuits, a set of electrical rails, and a signal buffer. More particularly, the plurality of pixel driver circuits may be configured to drive the plurality of pixel emitters based on signaling received from the display controller circuit. The set of electrical rails may include a ground rail configured to provide a ground voltage, a first voltage rail configured to provide a first voltage greater than the ground voltage, and a second voltage rail configured to provide a second voltage greater than the first voltage. The signal buffer (e.g., or another suitable type of electronic component) may be included within a pixel driver circuit of the plurality of pixel driver circuits. As described above, the signal buffer may have a ground terminal electrically coupled to the first voltage rail and a power terminal electrically coupled to the second voltage rail.

Still other implementations described herein may involve a device in accordance with principles described herein. Such a device may include an electric battery and a display assembly configured to be powered by the electric battery. Similar to the display assembly described above, the display assembly may include, among other elements, 1) a pixel emitter; 2) a set of electrical rails including a ground rail configured to provide a ground voltage, a first voltage rail configured to provide a first voltage greater than the ground voltage, and a second voltage rail configured to provide a second voltage greater than the first voltage; and 3) a pixel driver circuit configured to drive the pixel emitter, the pixel driver circuit including a signal buffer having a ground terminal and a power terminal, the ground terminal being electrically coupled to the first voltage rail (rather than to the ground rail) and the power terminal being electrically coupled to the second voltage rail.

Various additional implementations are explicitly described herein or may follow from principles described below. It will be understood that each of the examples mentioned above and described below may be implemented in different types of implementations. For example, the various display assemblies described herein could each be implemented in an array of different types of devices. Similarly, various rails, electronic components, and so forth, described herein in connection with one particular pixel driver circuit implementation could similarly be used in various other pixel driver circuit implementations, each of which may likewise be utilized by any of the display assemblies described herein.

The details of these and other implementations are set forth in the accompanying drawings and the description below. Other features will also be made apparent from the following description, drawings, and claims.

### BRIEF DESCRIPTION OF THE DRA WINGS

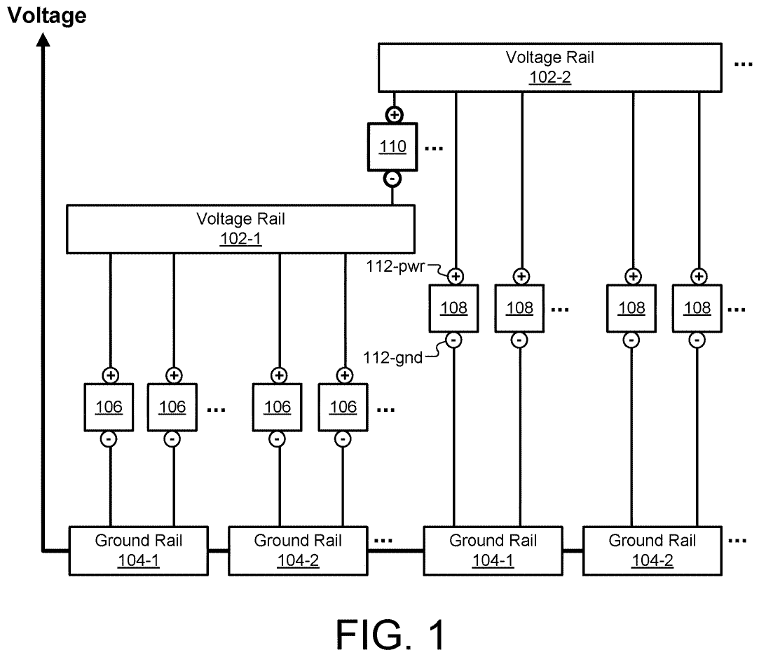

FIG. 1 shows illustrative electrical rails within an example circuit and various ways that components may be connected to the rails in accordance with principles described herein.

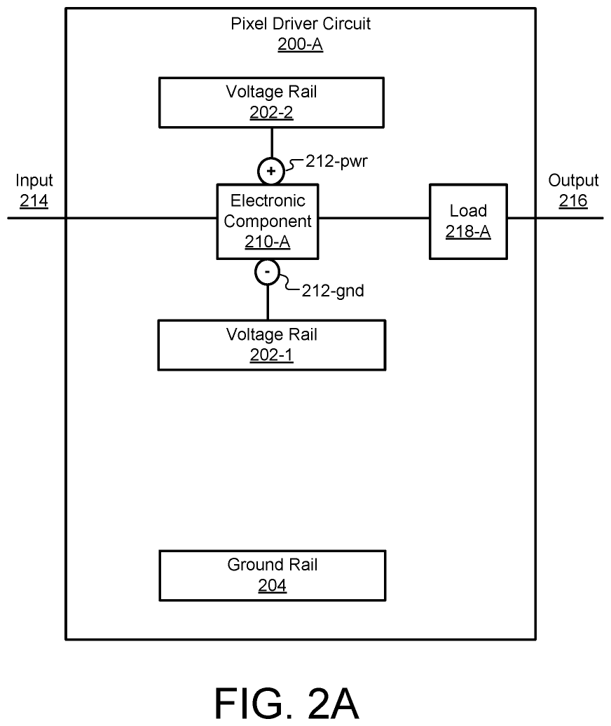

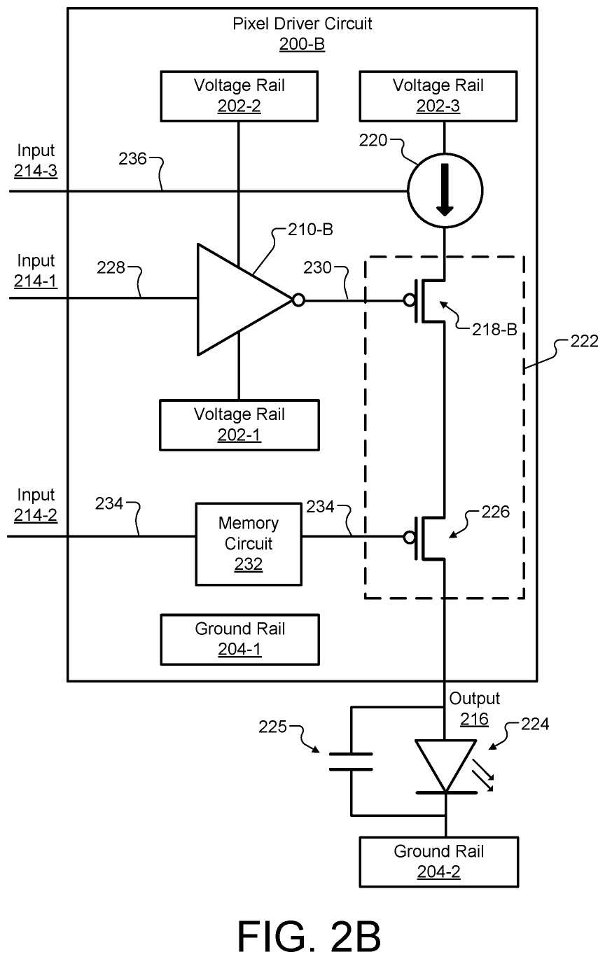

FIG. 2A shows an illustrative pixel driver circuit including a power-saving electronic component in accordance with principles described herein.

FIG. 2B shows an example of a more detailed implementation of the pixel driver circuit of FIG. 2A in accordance with principles described herein.

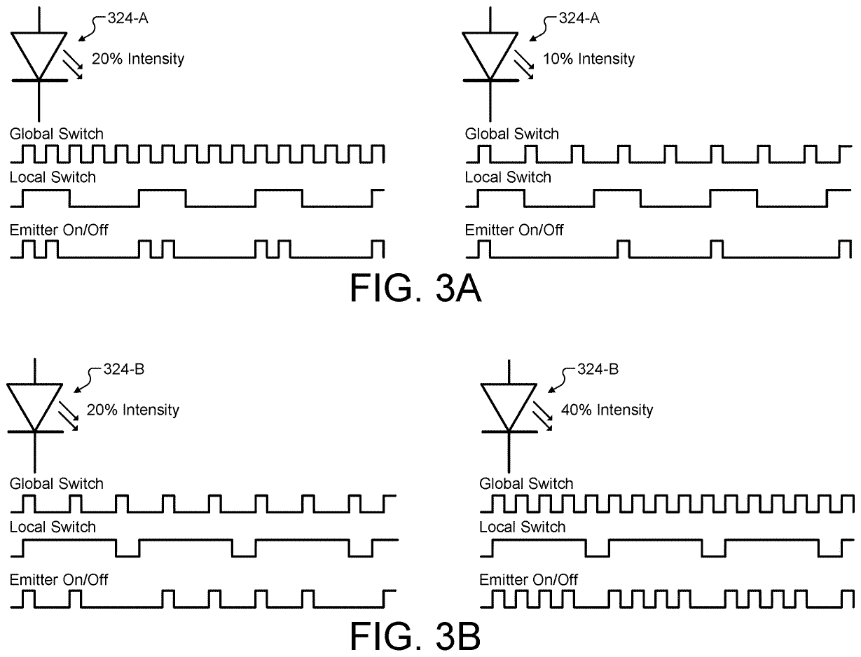

FIGS. 3A-3B show example waveforms illustrating the functionality of a multilevel pulse-width modulation (PWM) pixel emitter control scheme in accordance with principles described herein.

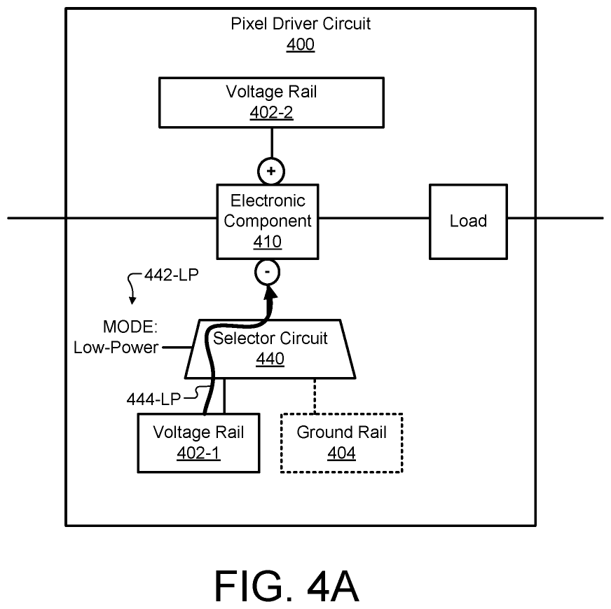

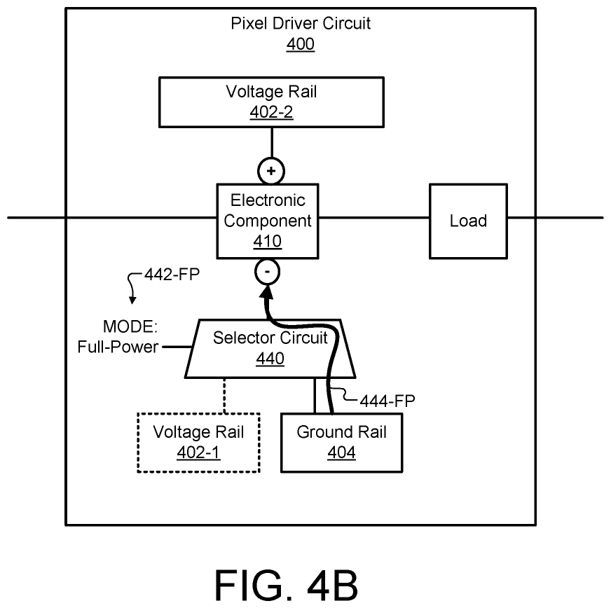

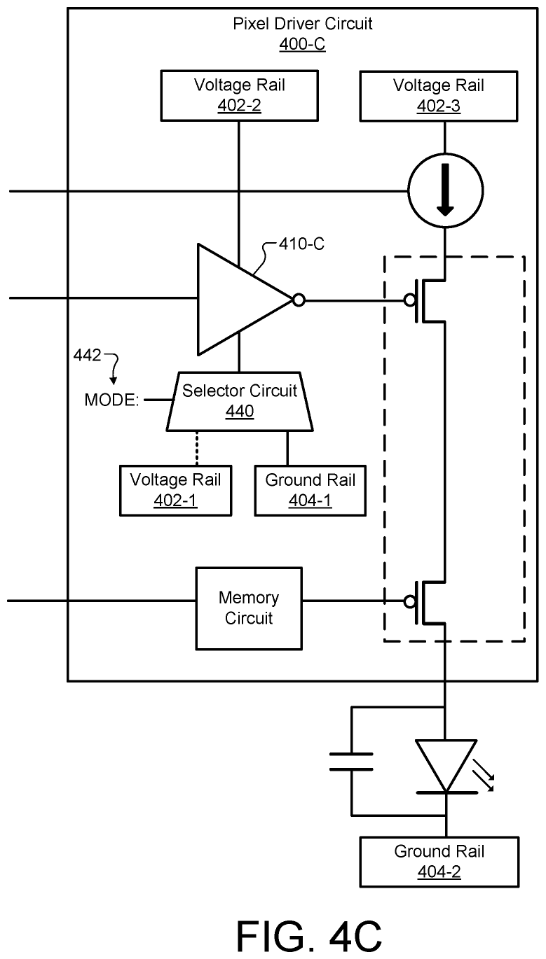

FIGS. 4A-4B show an illustrative pixel driver circuit including an electronic component with selectively-enablable power savings in accordance with principles described herein.

FIG. 4C shows an example of a more detailed implementation of the pixel driver circuit of FIGS. 4A-4B in accordance with principles described herein.

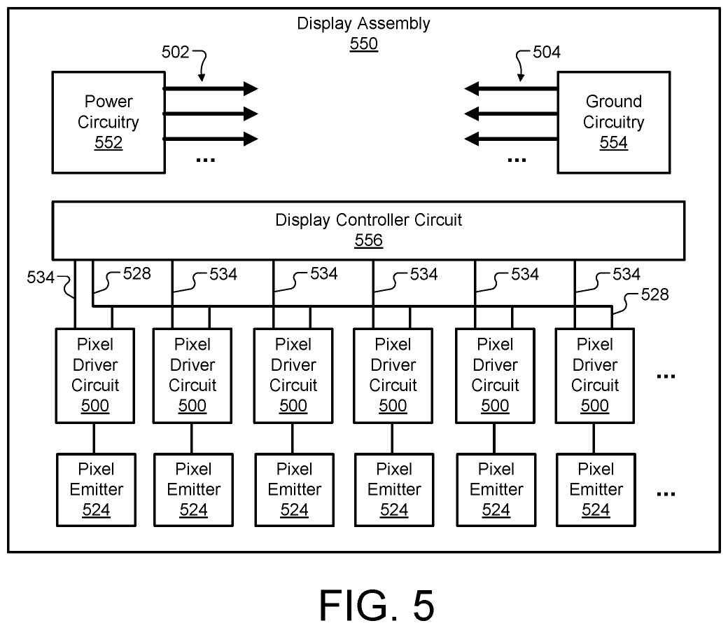

FIG. 5 shows an illustrative display assembly implementing a plurality of pixel driver circuits and other elements in accordance with principles described herein.

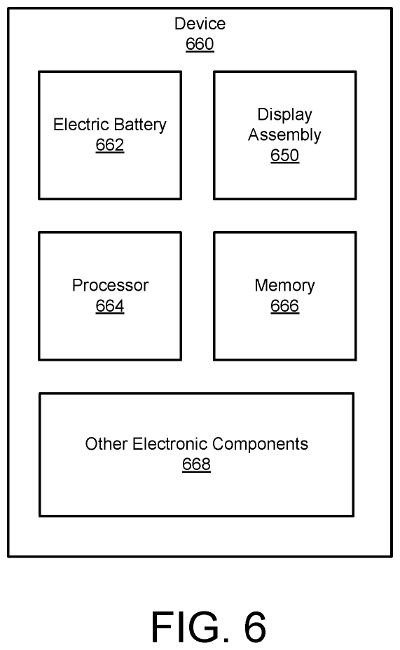

FIG. 6 shows an illustrative device implementing an electric battery, a display assembly, and other elements in accordance with principles described herein.

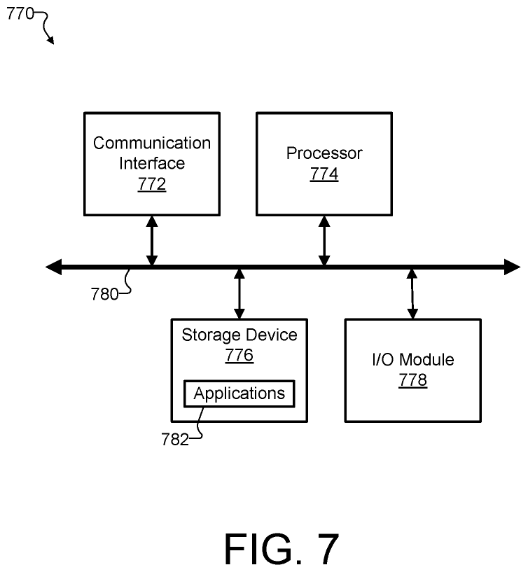

FIG. 7 shows an illustrative computing system that may be used to implement various devices and/or systems described herein.

### DETAILED DESCRIPTION

The design of any electronic device may target high performance with respect to a variety of attributes. For example, such attributes could include processing capacity and speed (where high performance may involve high-speed processors accessing significant memory and storage resources), footprint and form factor (where high performance may involve a desirable device size and a lightweight, streamlined, and attractive form), battery life (where high performance may involve a high capacity battery and highly efficient power usage to preserve the battery capacity), and/or other such characteristics or parameters. Different types of electronic devices may be designed to balance these and/or other attributes in different ways to achieve objectives specific to the device types and their respective uses and applications.

Most portable devices will be designed with significant emphasis on battery-related parameters, since a key factor in the usefulness of the device may be how long the device can be used on battery power before charging (or battery replacement) is required. However, certain ultra-portable devices face a particular technical problem in this regard, since their form factor may severely limit the amount of battery capacity that the device may access. As one example of such a device, a pair of extended reality (e.g., augmented reality, virtual reality, etc.) glasses will be considered. Certain extended reality devices (including some conventional extended reality head-mounted display devices) may provide ample space for a reasonably-sized battery within somewhat bulky head-mounted display components. Other conventional extended reality devices may utilize a separate battery component that is tethered to the head-mounted display components and configured to be carried in a pocket (or otherwise mounted off the head). Emerging extended reality devices such as extended reality glasses, however, may have a much more streamlined and lightweight form factor similar or identical to a typical pair of glasses (and without a separately tethered battery pack).

Enabling desired processing and display functions on such devices may be extremely challenging due to space limitations in where a battery can be integrated within such a form factor. These constraints limit the amount of battery capacity such devices have to work with, and similar technical problems may also be faced in the design of other wearable devices (such as smartwatches and/or smart rings) and other ultra-portable devices that may not necessarily be wearable but are similarly constrained with respect to size and weight. Even for larger mobile devices that may not be quite as constrained with respect to battery size and placement (e.g., smartphones, tablets, laptops, conventional head-mounted displays for extended reality devices, etc.), the technical problem of minimizing power usage to extend battery life (as well as to reduce heat, minimize weight, etc.) may also be extremely applicable.

One area in which minimizing power usage may be especially relevant for the types of devices described above is in the displays employed by the devices. As mentioned above, pixel emitters implemented as micro light emitting diodes (microLEDs) may represent one example technology that can be employed to conserve power while still providing a high level of display quality for ultra-portable devices such as extended reality glasses. A display assembly implementing microLED pixel emitters may include hundreds of thousands or millions of microLEDs, each of which may be associated with a respective pixel driver circuit. Accordingly, any power savings that can be implemented within the pixel driver circuit design may be multiplied across the display assembly to ultimately constitute significant power savings even if the savings provided to any individual pixel driver circuit is relatively modest.

At least one technical solution described herein to the challenge of minimizing power usage thus involves power-saving electronic components for pixel driver circuits. More particularly, power-saving signal buffers implemented within each pixel driver circuit of a display assembly may be used to process (e.g., buffer, level shift, invert, etc.) pulse-width modulation (PWM) signaling to thereby produce significant power savings for the display assembly. These power savings would also accrue to any device in which the display assembly is included, resulting in the technical effect of significant power savings for the device even if the savings for each individual pixel driver circuit is relatively small.

As will be described and illustrated in more detail, electronic components (such as signal buffers) may produce power savings within a pixel driver circuit by being connected in a different manner than electronic components would typically be connected. For example, rather than being connected between a power rail (e.g., at 2.5 V) and a ground rail (e.g., at 0 V) in the standard manner, a power-saving electronic component in accordance with principles described herein may be connected between two power rails (also referred to herein as voltage rails and understood to provide a non-zero voltage with respect to ground). A component could be connected, for instance, between a higher voltage rail (e.g., at 2.5 V) and a lower voltage rail (e.g., at 0.8 V) without any connection to a ground rail.

When connected in this way, power-saving electronic components may perform their desired function (e.g., buffering global, high-frequency PWM signals, etc.) while producing at least two power-saving technical effects. First, the voltage swing between the two voltage rails (e.g., 2.50 V−0.85 V=1.65 V) may be significantly less than the voltage swing between a voltage rail and a ground rail (e.g., 2.5 V−0.0 V=2.5 V). As such, the electronic component itself may consume significantly less power, particularly since power usage is not only dependent on voltage swing but dependent on the square of the voltage swing (as described in more detail below). Second, assuming the lower of the two voltage rails is also used to power other circuitry within the display assembly and/or the device, the power consumed by the electronic component as the potential drops from the higher voltage to the lower voltage may be effectively recycled and used by the other circuitry (as the potential drops from the lower voltage down to ground).

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods described herein for power-saving signal buffers for pixel driver circuits may result in any or all of the technical effects mentioned above, as well as various additional effects and benefits that will be described and/or made apparent below.

FIG. 1 shows illustrative electrical rails within an example circuit and various ways that electronic components may be connected to the rails in accordance with principles described herein. More particularly, a voltage rail 102-1, a voltage rail 102-2, a ground rail 104-1 and a ground rail 104-2 are shown to be connected in different ways to various electronic components 106, 108, and 110, each of which is shown to include a respective power terminal 112-pwr (drawn as a small circle on the top of the component and labeled “+”) and a respective ground terminal 112-gnd (drawn as a small circle on the bottom of the component and labeled “−”). While only one pair of terminals of one electronic component 108 is explicitly labeled with the 112-pwr and 112-gnd designators, FIG. 1 shows that each of the electronic components 106, 108, and 110 possesses such terminals. Moreover, while only a few voltage rails, ground rails, and electronic components are explicitly drawn in FIG. 1, it will be understood (as indicated by various ellipses (“ . . . ”) in the figure) that a given circuit may have more or fewer of each type of rail, and of each type of electronic component connected in the various ways illustrated.

Voltage rails 102-1 and 102-2 and ground rails 104-1 and 104-2 are shown in FIG. 1 to be drawn with respect to a vertical axis representing a voltage level (“Voltage”) that is provided by each of the various rails. More particularly, in this example, ground rails 104-1 and 104-2 will be understood to represent circuit nodes providing a reference voltage level associated with electrical ground (i.e., 0 V), voltage rail 102-1 will be understood to represent a circuit node providing a first voltage level greater than electrical ground, and voltage rail 102-2 will be understood to represent a circuit node providing a second voltage level greater than the first voltage level. To provide a few numerical examples, ground rails 104-1 and 104-2 could provide 0 V, voltage rail 102-1 could provide 0.85 V and voltage rail 102-2 could provide 2.50 V in one example. In another example, ground rails 104-1 and 104-2 could provide 0 V, voltage rail 102-1 could provide 2.5 V and voltage rail 102-2 could provide 3.3 V.

It will be understood that different rails in a circuit may provide the same voltage (e.g., such as illustrated in this example by ground rails 104-1 and 104-2) but may nonetheless be distinct rails (e.g., an analog ground and a digital ground) for various reasons beyond the scope of the disclosure. In some examples, such rails at the same voltage may be electrically coupled (e.g., by way of a resistor) to ensure that they provide the same voltage level. While there could also be other voltage rails providing similar or identical voltage levels as voltage rails 102-1 and/or 102-2 in certain circuit examples, however, it will be understood that, in this example, the voltage levels of voltage rails 102-1 and 102-2 may be distinct from one another, as illustrated.

Between the four rails represented in the example circuit of FIG. 1, electronic components 106 and 108 show various ways that electronic components can be connected between a voltage rail (also referred to as a power rail) and a ground rail. Specifically, as shown, certain electronic components 106 are connected between voltage rail 102-1 (on the respective power terminals 112-pwr) and ground rail 104-1 (on the respective ground terminals 112-gnd) while other electronic components 106 are connected between voltage rail 102-1 and ground rail 104-2. Similarly, certain electronic components 108 are connected between voltage rail 102-2 (on the respective power terminals 112-pwr) and ground rail 104-1 (on the respective ground terminals 112-gnd) while other electronic components 108 are connected between voltage rail 102-2 and ground rail 104-2.

The connections illustrated for electronic components 106 and 108 represent the typical way that components are interconnected in an electrical circuit for good reason. Such connections between a power rail and a ground rail allow for a complete circuit to be formed in which current may flow and the various components can operate properly. With the voltage rails providing a source of electrical energy (i.e., the voltage for operating the components) and the ground rails providing a reference point for the circuit, a closed loop (i.e., a complete circuit) is formed in which current is able to flow from the power source through the components and back. This current flow enables the electrical components to perform their intended functions (e.g., lighting up an LED, amplifying a signal, storing a value, processing data, etc.), or, in other words, power rails and ground rails provide conditions for electronic components connected between them to operate as they ensure that there is a voltage difference to drive current and a complete path for that current to flow.

Given this standard way of connecting components and the good reasons for it, electronic component 110 is shown to be connected in an unusual way. Rather than being connected between power and ground (i.e., between a voltage rail and a ground rail) in the way electronic components 106 and 108 are, electronic component 110 is connected between two power rails. More particularly, as shown, electronic component 110 is connected between voltage rail 102-2 (on its power terminal 112-pwr) and voltage rail 102-1 (on its ground terminal 112-gnd). While the multi-voltage-rail connections used for electronic component 110 are abnormal and to be made with care to ensure that electronic component 110 will be able to operate properly given the voltage difference between voltage rails 102-2 and 102-1, a technical effect of these unusual connections may be highly advantageous for certain applications. Specifically, as has been mentioned, a significant power-saving benefit may arise both from reducing the voltage swing that electronic component 110 switches between, as well as recycling the energy used to operate electronic component 110 for use in operating electronic components 106.

The power saving benefit gained in this way may be especially notable given that power consumption of a switching component is proportional to the square of the voltage swing associated with operating the component. This is illustrated by Equation 1:

$$P = \frac{1}{2} * C * {V}^{2} * f \qquad ( Eq . 1 )$$

where P represents the power consumed by charging or discharging a load with a capacitance C to a voltage V with an average frequency f.

To provide a numerical example of the potential savings, an electronic component 110 will be compared to an electronic component 108 in a scenario where voltage rail 102-2 is assumed to be 3.3 V, voltage rail 102-1 is assumed to be 2.5 V, and both components are assumed to be driving a load with a capacitance of 1 picofarad (pF) at an average frequency of 100 MHz (i.e., charging and discharging the load 100 million times per second). Based on Equation 1, an electronic component 108 connected between voltage rail 102-2 and ground rail 104-1 (for a total voltage swing of 3.3 V−0.0 V=3.3 V) would consume: 1/2*1 pF*(3.3 V)²*100 MHz=544 μW. In contrast, Equation 1 indicates that an electronic component 110 connected between voltage rail 102-2 and voltage rail 102-1 (for a total voltage swing of 3.3 V−2.5 V=0.8 V) would consume: 1/2*1 pF*(0.8 V)²*100 MHz=32 μW. For this example, the decrease in power usage of the component is significant: from 544 μW to 32 μW for approximately a 94% decrease in the power consumption of the component.

Even if the voltages do not provide power savings quite as dramatic as this example (e.g., if the voltage rails were, respectively, 2.5 V and 0.8 V, there would be a power savings of about 168 μW for approximately a 54% decrease), the overall savings may still clearly be significant, especially considering the power that may be recycled for use by electronic components 106 and considering that there may be thousands or millions of power-saving electronic components 110 in certain applications, as will described in more detail below.

FIG. 2A shows an illustrative pixel driver circuit 200-A including a power-saving electronic component in accordance with principles described herein. More particularly, as shown, pixel driver circuit 200-A includes a voltage rail 202-1 and a voltage rail 202-2 providing a higher voltage level than voltage rail 202-1. Both of these may provide higher voltage levels than a ground rail 204 (which may or may not be used within pixel driver circuit 200-A and may be used elsewhere in a device implementing pixel driver circuit 200-A). Moreover, an electronic component 210-A having a power terminal 212-pwr and a ground terminal 212-gnd is shown to be connected between voltage rails 202-1 and 202-2 (rather than being connected to ground rail 204 as electronic components may be connected more typically). Illustrative pixel driver circuit 200-A is further shown to include an input 214 connecting to electronic component 210-A, an output 216, and a load 218-A that may be driven by an output of electronic component 210-A and that itself may connect to output 216.

In FIG. 2A and other figures described herein, the reference numbers and labels used are configured: 1) to indicate which figure the elements are associated with (i.e., the first digit of the three-digit reference numbers), 2) to provide a designation whereby the elements may be clearly referenced in the written description (i.e., the last two digits of the three-digit reference numbers), 3) as applicable, to consistently indicate a relationship between similar or identical elements in the same or other figures (i.e., all three digits or the last two digits of the reference numbers), and 4) to distinguish between similar elements or different implementations of the same element (i.e., letters following a hyphen after certain three-digit reference numbers).

For example, electronic component 210-A uses a reference number that indicates: 1) the figure(s) to which the component corresponds (‘2’ to indicate FIGS. 2A and 2B); 2) a unique designation (‘10’) that differentiates electronic component 210-A from other elements in FIGS. 2A and 2B that also begin with a ‘2’; 3) a consistent correlation to other similar elements (e.g., other electronic components or implementations thereof that are connected between two voltage rails) referenced in other figures and description in this disclosure; and 4) a unique designation (‘-A’) to distinguish this generic electronic component (which may represent a variety of different types of components) from more specific implementations of the component (e.g., such as a signal buffer 210-B implementing the electronic component 210-A and described in more detail below).

To provide a few other examples of this notation, voltage rails 202-1 and 202-2 will be understood to have various similarities with voltage rail 102-1 and voltage rail 102-2 described above, as well as with other voltage rails X02-1 and X02-2 described below (where ‘X’ represents other figure numbers below). Similarly, ground rail 204 is similar to either of ground rails 104-1 or 104-2 (though no hyphenated portion is required in FIG. 2A to distinguish between different ground rails), as well as to other ground rails X04 below, and so forth. As yet another example, pixel driver circuit 200-A represents a generic pixel driver circuit, while a pixel driver circuit 200-B (described in relation to FIG. 2B) represents a more specific implementation of pixel driver circuit 200-A and other pixel driver circuits in other figures below are similarly labeled “X00” (possibly followed by a hyphenated portion) to indicate their similarity with circuits such as pixel driver circuits 200-A and 200-B.

As shown, pixel driver circuit 200-A includes a first voltage rail 202-1 configured to provide a first voltage, the first voltage being greater than a ground voltage provided by a ground rail 204. For example, the first voltage could be 0.85 V in one example, while the ground voltage would be 0 V. Pixel driver circuit 200-A further includes a second voltage rail 202-2 configured to provide a second voltage, the second voltage being greater than the first voltage provided by the first voltage rail 202-1. For example, the second voltage could be 2.50 V in one example. Pixel driver circuit 200-A further includes an electronic component 210-A having a ground terminal 212-gnd and a power terminal 212-pwr, the ground terminal 212-gnd being electrically coupled to voltage rail 202-1 and the power terminal 212-pwr being electrically coupled to voltage rail 202-2, as shown.

Electronic component 210-A may represent a signal buffer for a PWM signal (as described in various more specific examples below) or another suitable type of electronic component as may serve a particular implementation. Similarly, load 218-A may represent a switching mechanism (e.g., a gate capacitance of a P-type metal-oxide-semiconductor (PMOS) field effect transistor, etc.) or another suitable load as may serve a particular implementation. Input 214 and output 216 may then be associated with various types of signals depending on how electronic component 210-A and load 218-A are implemented and the function they are configured to serve.

To illustrate, FIG. 2B shows an example of a more detailed implementation of pixel driver circuit 200-A in accordance with principles described herein. Specifically, similar to pixel driver circuit 200-A, a pixel driver circuit 200-B in FIG. 2B is shown to include voltage rails 202-1 and 202-2, between which is connected an electrical component receiving a signal from an input 214-1. In this example, the generic electronic component 210-A is shown to be implemented as a signal buffer 210-B that drives the gate of a PMOS transistor 218-B serving as a global PWM switch. A ground rail 204-1 (similar to the ground rail 204 shown in pixel driver circuit 200-A) is also shown within pixel driver circuit 200-B. While ground rail 204-1 (like ground rail 204 of pixel driver circuit 200-A) is not shown to be connected to any component in this example, it is included in the figure to emphasize that the ground terminal of signal buffer 210-B is coupled with voltage rail 202-1 rather than with ground rail 204-1 (though other electrical components within pixel driver circuit 200-B that are not explicitly shown could be connected thereto).

Along with these elements that have analogs in FIG. 2A described above, FIG. 2B also shows several additional elements. For example, pixel driver circuit 200-B is shown to include a current source 220 and a switch network 222. Current source 220 may be configured, when switch network 222 is in a particular state, to cause a pixel emitter 224 with an associated capacitance 225 to emit light. For example, pixel emitter 224 may be implemented as a microLED or another suitable type of pixel emitter, and, as shown, output 216 from pixel driver circuit 200-B may be electrically coupled to pixel emitter 224 so that pixel driver circuit 200-B can drive pixel emitter 224 (e.g., switching the microLED on and off at appropriate times) based on the state of switch network 222. It will be understood that associated capacitance 225 may represent a capacitance inherent to pixel emitter 224, rather than an added capacitor component.

Switch network 222 is shown in this example to include a first switch and a second switch electrically coupled in series between current source 220 and pixel emitter 224. Each of these switches is implemented, in this example, as a respective PMOS transistor (i.e., PMOS transistor 218-B and PMOS transistor 226) that, when switched on (i.e., when the gate is driven low), allows current to pass. Accordingly, when both gates of PMOS transistor 218-B and PMOS transistor 226 are driven low at the same time, this particular state of switch network 222 allows current to pass from current source 220, through switch network 222 and output 216, to then drive pixel emitter 224 to emit light. Conversely, when either or both of the gates of PMOS transistor 218-B and 226 are driven high, the resulting state of switch network 222 would disallow current flow to cause light emission to cease.

The first switch of the switch network (e.g., PMOS transistor 218-B of switch network 222 in this example) may be configured as a global PWM switch that is controlled by a signal buffer (e.g., signal buffer 210-B) based on a global PWM signal 228 provided to pixel driver circuit 200-B and a plurality of other pixel driver circuits (not explicitly shown in FIG. 2B). In other words, global PWM signal 228 will be understood to be a global signal in the sense that it is shared by more than one (and possibly all) of the pixel driver circuits in a particular display assembly (e.g., thousands or millions of pixel driver circuits in certain examples). Global PWM signal 228 is shown to be received by pixel driver circuit 200-B on input 214-1, after which the signal may be inverted, level-shifted, and/or otherwise processed by signal buffer 210-B. For example, signal buffer 210-B may be implemented as an inverting buffer in this example, so that when global PWM signal 228 is high, signal buffer 210-B provides an inverted version of the signal (labeled in FIG. 2B as global PWM signal 230) into the gate of PMOS transistor 218-B. Global PWM signal 228 and its role in a two-level PWM emitter control scheme used by pixel driver circuit 200-B will be described in more detail below.

The second switch of the switch network (e.g., PMOS transistor 226 of switch network 222 in this example) may be configured as a local PWM switch controlled by a memory circuit 232 configured to store a local PWM signal 234 customized specifically for pixel driver circuit 200-B and not shared by the plurality of other pixel driver circuits. In other words, local PWM signal 234 will be understood to be a local signal in the sense that it is not shared by all the pixel driver circuits, but, rather, is specific to an individual pixel. Local PWM signal 234 is shown to be received by pixel driver circuit 200-B in input 214-2, after which the signal is stored by memory circuit 232. By storing local PWM signal 234, memory circuit 232 may allow pixel driver circuit 200-B to maintain pixel emitter 224 at a continuous intensity without needing to be updated for frames in which the intensity does not change. This too may provide significant efficiencies since pixels that are not changing from frame to frame do not need to be updated for every frame. Local PWM signal 234 and its role in the two-level PWM emitter control scheme used by pixel driver circuit 200-B will also be described in more detail below.

In the operation of a display assembly, pixel driver circuit 200-B may represent one pixel driver circuit of a plurality of pixel driver circuits that could include thousands or millions of similar circuits, each driving one pixel emitter (e.g., a red pixel emitter, a green pixel emitter, a blue pixel emitter, etc.). In some examples, pixel driver circuit 200-B could be modified such that it would drive a pixel emitter that includes a group of individual emitters. For instance, a pixel emitter could be implemented as a group including an individual red, green, and blue microLEDs (or other suitable type of emitters) that collectively form a pixel emitter that can produce any color.

Focusing on the individual pixel driver circuit 200-B (with an understanding that the following operations may be performed by many parallel circuits across a display panel), a bias signal 236 may be received at input 214-3 and may influence an amount of current produced by current source 220, which may draw power from a voltage rail 202-3. Voltage rail 202-3 may be configured to provide power at a voltage level that is high enough to properly supply current source 220 for driving pixel emitter 224 (after any small drops caused by parasitics of switch network 222) while being no more than the voltage level of voltage rail 202-2. In some examples, voltage rail 202-2 could be used to power current source 220 rather than a separate rail.

As has been described, current produced by current source 220 may only reach output 216 and pixel emitter 224 being driven by this pixel driver circuit if switch network 222 is in a particular state. More particularly, current may flow whenever PMOS transistor 218-B and PMOS transistor 226 are switched on by the voltage at their respective gates being driven low enough (by global PWM signal 230 and local PWM signal 234, respectively) to allow these PMOS transistors to conduct current. When these switches are on, capacitance 225 may become sufficiently charged for pixel emitter 224 to emit light and a voltage drop across pixel emitter 224 from the voltage level of voltage rail 202-3 to a neutral voltage level of ground rail 204-2 may be produced as the circuit is completed and current flows. Ground rail 204-2 may be the same as ground rail 204-1 in some examples, or at least may provide the same neutral voltage level (i.e., 0 V). In some examples, ground rail 204-2, where a cathode of the microLED is coupled, may represent a common cathode node (e.g., a rail CCR(-ve)) that provides a return for many such pixel emitters.

Images (e.g., video frames, etc.) may be produced on a display panel featuring an array of pixel emitters by driving pixels across the array to colors and intensities called for by the image being displayed. For a red-green-blue (RGB) microLED color scheme, both the color and intensity of any given pixel may ultimately be produced by carefully driving red, green, and blue pixel emitters so that they are on (emitting light) for a first percentage of a given frame time and off (not emitting light) for the remainder of the frame time. For example, if a pixel emitter were to be driven for an entirety of a frame time, that pixel would appear at maximum brightness, while if the pixel emitter were not driven at all during the frame time, the pixel would be black. Between these extremes, the pixel could be driven for 10% of the frame time to produce a dim pixel, 50% of the frame time to produce a moderate intensity pixel, 75% of the time to produce a bright (though not maximally bright) pixel, and/or any other suitable percentage as the image data may call for. Not only can image brightness be controlled in this way, but color itself may be produced by controlling the relative brightness of RGB pixels in a given pixel group so that a full color palette becomes available based on combinations of red, green and blue light intensities.

Controlling pixel brightness and color in this way is referred to as pulse-width modulation (PWM) of a pixel emitter and this may be done using various control techniques that are largely beyond the scope of this disclosure. It is noted, however, that the total portion of a frame time that a pixel emitter is driven on or off may be distributed across the frame time. In other words, if a pixel is to be driven at 50% intensity, the emitter may, rather than being on for the first half of a frame period and then off the second half, be quickly toggled on and off many times during the frame period so that by the end it has spent the same amount of time emitting light as not emitting light.

Pixel driver circuit 200-B supports a two-level PWM emitter control scheme involving both local and global control of pixel emitter 224. More particularly, local control of pixel emitter 224 may be exerted using input 214-2 and local PWM signal 234 (which may be stored, as described above, by memory circuit 232) to control pixel emitter 224 relative to other pixels. At the same time, global control of pixel emitter 224 and all the other pixel emitters of a given display panel (not shown in FIG. 2B) may also be exerted so that, for example, the brightness of the entire display may be turned up and down without affecting the brightnesses of the pixels relative to one another (and, therefore, without affecting the presentation of the image other than to change its overall brightness). The local and global control of the pixel emitter therefore operate in conjunction with one another to control, for any given frame time, exactly what intensity pixel emitter 224 is to be driven with (i.e., to control what percentage of the frame time the pixel emitter 224 is emitting light versus what percentage it is turned off).

Due to response times of signal buffer 210-B and memory circuit 232 (as well as other details beyond the scope of this disclosure), the two-level PWM emitter control scheme may potentially toggle PMOS transistor 218-B significantly faster than PMOS transistor 226 is toggled. For example, depending on the intensity desired for pixel emitter 224 at a given time, global PWM signal 228 may toggle at a first average frequency, local PWM signal 234 may toggle at a second average frequency, and the first average frequency may be at least double the second average frequency (and, in some examples significantly faster than that, such as 8 times the second average frequency, 16 times the second average frequency, etc.).

To illustrate how multilevel PWM control schemes may function, FIGS. 3A-3B show example waveforms illustrating the functionality of the two-level PWM pixel emitter control scheme supported by pixel driver circuit 200-B. Specifically, each figure shows examples of pixel emitters 324-A (in FIG. 3A) or 324-B (in FIG. 3B) being driven to different intensity levels indicated based on pulse-width modulation (i.e., based on how long, on average, the pixel emitter is emitting light versus not emitting light). It will be understood that these waveforms are shown for the purpose of illustrating a potential interplay between the two levels (local and global) of PWM pixel emitter control. However, the actual waveforms in certain implementations could be considerably different (e.g., more complex) to account for various factors beyond the scope of this disclosure.

FIG. 3A shows differences in how a “Global Switch” (e.g., PMOS transistor 218-B, as driven based on global PWM signal 228, signal buffer 210-B and the inverted global PWM signal 230) and a “Local Switch” (e.g., PMOS transistor 226, as driven based on local PWM signal 234 as stored by memory circuit 232) could be toggled when a pixel emitter 324-A is to be driven at 20% intensity (on the left-hand side of FIG. 3A) and then reduced to 10% intensity (on the right-hand side of FIG. 3A). More specifically, the intensity decrease is shown to come from changes to the global switching while the local switching stays the same (representing a dimming of the entire display).

As shown in FIG. 3A, when pixel emitter 324-A is producing 20% intensity on the left, the local switching may be set to be on 40% of the time such that the global switch may have a 50% duty cycle to reduce this 40% intensity to the desired 20% intensity. The waveform labeled “Emitter On/Off” shows a high level (representing light emission) only when both the global and the local switches are high (representing when the switches are on or when the gate is pulled low in the PMOS transistor example of FIG. 2B), while showing a low level (representing no light emission) when either switch is off. As shown, this results in the pixel emitter being on 20% of the time, with the global switch being toggled much faster than the local switch. Based on global changes to the display, however, the pixel emitter 324-A is later shown (on the right) to produce only 10% intensity. As shown, the local switching may still be on 40% of the time, but the duty cycle of the global switch may be reduced to 25% to reduce the 40% intensity to the desired 10% intensity. As shown, the waveform labeled “Emitter On/Off” shows a high level (representing light emission) only 10% of the time in this example, while showing a low level (representing no light emission) the rest of the time. Still, however, the global switch is shown to be toggled at a higher average frequency than the local switch.

FIG. 3B then shows differences in how the global switch and the local switch could be toggled when a pixel emitter 324-B is to be driven at 20% intensity (on the left-hand side of FIG. 3B) and then increased to 40% intensity (on the right-hand side of FIG. 3B). In this example again, the intensity increase is shown to come from changes to the global switching while the local switching stays the same, thus representing a brightening of the entire display.

As shown in FIG. 3B, when pixel emitter 324-B is producing 20% intensity on the left, the local switching may be set to be on 80% of the time such that the global switch may have a 25% duty cycle to reduce this 80% intensity to the desired 20% intensity. Here again, the waveform labeled “Emitter On/Off” shows a high level (representing light emission) only when both the global and the local switches are high (representing when the switches are on or when the gate is pulled low in the PMOS transistor example of FIG. 2B), while showing a low level (representing no light emission) when either switch is off. As shown, this results in the pixel emitter being on 20% of the time, with the global switch being toggled considerably faster than the local switch. Based on global changes to the display, however, the pixel emitter 324-B is later shown (on the right) to be increased to 40% intensity. As shown, the local switching may still be on 80% of the time, but the duty cycle of the global switch may be increased to 50% to cause the 80% intensity to only be reduced to the desired 40% intensity. As such, the waveform labeled “Emitter On/Off” shows a high level (representing light emission) 40% of the time in this example, while showing a low level (representing no light emission) the rest of the time. The global switch is shown to still be toggling at a higher average frequency than the local switch.

A signal buffer such as signal buffer 210-B may be toggled very quickly, making it possible to toggle a switch like PMOS transistor 218-B rapidly (e.g. much more rapidly than PMOS transistor 226 may be toggled based on local PWM signal 234), as has been described. As a result, the power consumed by signal buffer 210-B as global PWM signal 230 is rapidly toggled (e.g., with an average frequency in the 100s of MHz in certain implementations) allows for significant power savings when the voltage swing is reduced by any amount.

It is noted that the function of signal buffer 210-B in charging and discharging the gate of PMOS transistor 218-B may require signal buffer 210-B to be powered at a voltage level that is on par with (e.g., at least as great as) the level used to drive pixel emitter 224 (i.e., the voltage of voltage rail 202-3), thus precluding reducing the voltage swing by lowering the voltage level of voltage rail 202-2 itself. At the same time, there is a limit to how high the voltage level of voltage rail 202-1 may be so that signal buffer 210-B is properly powered (i.e., the voltage swing is sufficient) to produce a global PWM signal 230 to effectively charge and switch PMOS transistor 218-B. Moreover, while significant power savings detailed herein may be achieved by connecting the signal buffer between the two voltage rails to decrease the voltage swing and recycle the power (i.e., save some of the voltage drop) for use by other components, it will also be understood that increased performance (e.g., faster switching speeds, etc.) may be achieved when the signal buffer has a relatively greater voltage swing, such as may be achieved by connecting the ground terminal to an actual ground rail in the conventional way. In other words, there may be a tradeoff between the speed/performance of the circuit and the reduced power consumption desired for the circuit.

While this tradeoff may be managed in some implementations by the design of the circuit itself (e.g., based on which rails the signal buffer is connected to), it may also be desirable in certain implementations to provide some flexibility so that this tradeoff can be made in different ways under different circumstances in which the pixel driver circuit may be used. For example, when performance is a greater concern (e.g., during a testing phase of the design, when the device is plugged in such that the circuit is not running on battery power, when implemented in applications that require very high frame rates or that are not particularly power sensitive, etc.) it may be useful to put the pixel driver circuit in a full-power (i.e., high-performance) mode even if that means that the signal buffer will consume more power. On the other hand, when power consumption is a greater concern (e.g., when the circuit is in use and on battery power in an application that is sensitive to power consumption), it may be useful to put the pixel driver circuit into a low-power mode even if the performance potential may be somewhat compromised thereby.

To implement these types of modes, a pixel driver circuit may include a selector circuit configured to selectively couple either a voltage rail (e.g., the first voltage rail 202-1) or a ground rail (e.g., the ground rail 204-1) to the ground terminal of the signal buffer. With this selector circuit in place, pixel driver circuit may be configured to operate in either: 1) a low-power mode in which the selector circuit couples the ground terminal to the first voltage rail while the power terminal is coupled to the second voltage rail (e.g., voltage rail 202-2), or 2) a full-power mode in which the selector circuit couples the ground terminal to the ground rail while the power terminal is coupled to the second voltage rail.

To illustrate, FIGS. 4A-4B show an illustrative pixel driver circuit 400 including an electronic component with selectively-enablable power savings in accordance with principles described herein. FIGS. 4A and 4B are similar to FIG. 2A described above, but add a selector circuit configured to connect the ground terminal to either a voltage rail or a ground rail based on a mode that the pixel driver circuit is configured to operate in a given time. FIG. 4C then shows an example of a more detailed implementation of the pixel driver circuit of FIGS. 4A-4B in accordance with principles described herein. That is, just as FIG. 2B added implementation details to the generalized implementation of FIG. 2A, FIG. 4C shows additional implementation details (similar to those described above in relation to FIG. 2B) for the pixel driver circuit described in relation to FIGS. 4A-4B. In FIGS. 4A-4C, voltage and ground rails, as well as other elements relevant to the description of mode selection being illustrated, are labeled with reference numbers in accordance with the numbering scheme described above. Other elements are not explicitly numbered in these figures and will be understood to perform the same or similar roles as described above in relation to FIGS. 2A-2B.

In FIGS. 4A and 4B, pixel driver circuit 400 is shown to include a first voltage rail 402-1, a second voltage rail 402-2, and a ground rail 404, between which an electronic component 410 having a power terminal and a ground terminal is connected. While the power terminal is shown to be directly coupled to the higher voltage rail 402-2 (in like manner as described above with electronic component 210-A and voltage rail 202-2), the ground terminal is shown to be selectively coupled to either voltage rail 402-1 or ground rail 404 by way of a selector circuit 440. Selector circuit 440 may be implemented as a multiplexor circuit or other suitable selection circuitry that is configured to electrically couple the ground terminal of electronic component 410 to either of the rails based on a selection input associated with a selected operation mode.

In FIG. 4A, the selected operation mode is shown to be a low-power mode 442-LP (“LP” for “Low-Power”). As such, the selection input to selector circuit 440 may be set (e.g., by a display controller circuit or the like) to a value associated with the low-power mode 442-LP. In this configuration, FIG. 4A is shown with an electrical coupling 444-LP that connects the ground terminal of electronic component 410 to voltage rail 402-1. In this example, ground rail 404 is drawn with dotted lines indicative of the fact that it is not being selected in low-power mode 442-LP. Accordingly, in this low-power mode 442-LP, it will be understood that electronic component 410 may have a lower voltage swing and the energy used to power it may be recycled by other electronic components (not shown in FIG. 4A) that are powered by voltage rail 402-1. As has been described, this may allow electronic component 410 to use considerably less power (particularly if it is switching quickly), which benefit may be multiplied by a potentially large number of pixel driver circuits that may be present in a given display assembly.

In contrast, FIG. 4B shows a full-power mode 442-FP (“FP” for “Full-Power”) that, while lacking the power savings of the low-power operation mode 442-LP described above, may be used as a high-performance operation mode (e.g., allowing electronic component 410 to switch more rapidly or effectively). The selection input of selector circuit 440 in this example may be driven (e.g., again by the display controller circuit or the like) to a value associated with the full-power mode 442-FP. In this configuration, an electrical coupling 444-FP is shown that connects the ground terminal of electronic component 410 to ground rail 404. Accordingly, voltage rail 402-1 is drawn with dotted lines indicative of the fact that it is not being selected in full-power mode 442-FP. In this full-power mode 442-FP, it will be understood that electronic component 410 may have a wider voltage swing and more performance capability.

FIG. 4C shows a pixel driver circuit 400-C with the additional features described above in relation to FIG. 2B, but also including the selector circuit 440 to select between modes 442. That is, when a low-power mode 442 is selected, selector circuit 440 may connect the ground terminal of a signal buffer 410-C to voltage rail 402-1 while the power terminal of the signal buffer 410-C is electrically coupled to voltage rail 402-2. Conversely, when a full-power mode 442 is selected, selector circuit 440 may connect the ground terminal of signal buffer 410-C to a ground rail 404-1 while the power terminal continues to be electrically coupled to voltage rail 402-2. As described in relation to FIG. 2B, a third voltage rail 402-3 is also shown to power a current source that passes current through a pixel emitter to a ground rail 404-2 when the switch network is in a particular state.

As has been mentioned, a pixel driver circuit in accordance with principles described herein (e.g., any of pixel driver circuits 200-A, 200-B, 400, 400-C, etc.) may be configured to interoperate with additional circuitry within a display assembly. For example, the display assembly may include a display controller circuit, a number of other pixel driver circuits driving their own respective pixel emitters, and other circuitry. At least one electronic component within the additional circuitry of a display assembly may be powered by recycled power that was used for the signal buffer, as has been described. For example, this additional electronic component may have its own ground terminal and power terminal (“second” ground and power terminals if the terminals of the signal buffer are the “first” ground and power terminal). This second ground terminal may be electrically coupled to a ground rail and the second power terminal may be electrically coupled to the first voltage rail that is connected to the first ground terminal of the signal buffer.

Also mentioned above is how the power savings may be multiplied when a plurality of electronic components included within a plurality of pixel driver circuits are included in a single display assembly and driven by a common signal that may be switching at a relatively high average frequency. For example, a signal buffer in one pixel driver circuit may include a signal input terminal that is electrically coupled to a global PWM signal generator, such as may be included within a display controller circuit. This signal input terminal may be, for example, where global PWM signal 228 is received by signal buffer 210-B. Given a display assembly with a large number of pixel driver circuits, the PWM signal generator may generate the global PWM signal to fan out and connect to each of the pixel driver circuits so that the global PWM switch can globally brighten or dim the display in the ways that have been described.

To illustrate how a pixel driver circuit such as those that have been described may contribute to a power-saving display assembly, FIG. 5 shows an illustrative display assembly 550 that implements a plurality of pixel driver circuits 500 and other elements in accordance with principles described herein. As shown, display assembly 550 may include circuitry configured to produce a set of electrical rails used within the display assembly. For example, power circuitry 552 may be configured to produce a set of voltage rails 502, while ground circuitry 554 may be configured associated with a set of one or more ground rails 504. The set of voltage rails 502 and ground rails 504 may be similar to those voltage and ground rails that have been described (e.g., voltage rails 202-1, 202-2, 202-3; ground rails 204-1 and 204-2; etc.). For example, the rails may include at least a ground rail 504 configured to provide a ground voltage, a first voltage rail 502 configured to provide a first voltage greater than the ground voltage, and a second voltage rail 502 configured to provide a second voltage greater than the first voltage.

Display assembly 550 is further shown to include a plurality of pixel emitters 524 (e.g., microLEDs with associated capacitances similar to pixel emitter 224 and other pixel emitters described herein) associated with a plurality of pixel driver circuits 500 that are configured to drive the plurality of pixel emitters 524. A display controller circuit 556 is shown to provide signaling to the pixel driver circuits 500, upon which the driving of the plurality of pixel emitters 524 may be based. Specifically, as shown, display controller circuit 556 is shown to provide unique or individual local PWM signals 534 to each pixel driver circuit 500. Additionally, display controller circuit 556 is shown to provide a global PWM signal 528 that is shared by all of the pixel driver circuits 500. Each of the pixel driver circuits 500 of display assembly 550 will be understood to be an implementation of a pixel driver circuit such as pixel driver circuit 200-A or 200-B described above. As such, each of these pixel driver circuits 500 may include a respective electronic component (e.g., such as electronic component 210-A or signal buffer 210-B) that has a ground terminal electrically coupled to (or at least selectively couplable to) the first (lower-voltage) voltage rail 502, along with a power terminal electrically coupled to the second (higher-voltage) voltage rail 502.

A display assembly such as display assembly 550 may be implemented in a variety of different types of electronic devices. For example, as described above, a display assembly with the power efficiency of display assembly 550 may be used to great effect in devices where low power consumption is prioritized, such as certain extended reality devices (e.g., augmented reality glasses, etc.), wearables such as smart watches and rings, and so forth.

To illustrate an example of how a display assembly may be used within a device, FIG. 6 shows an illustrative device 660 implementing an electric battery 662, a display assembly 650 configured to be powered by the electric battery, and other elements in accordance with principles described herein. The electric battery 662 may be a rechargeable or non-rechargeable battery using any suitable battery technology as may serve a particular implementation. In some implementations, electric battery 662 may have a relatively small capacity, such as in the hundreds of milliamp hours. As has been described, the form factor of certain types of devices (e.g., extended reality glasses, smart watches, etc.) may not allow for a battery with more capacity than this, therefore underscoring the high priority for display assembly 650 and the other elements to be efficient with the power they consume.

The display assembly 650 may be an implementation of the display assembly 550 described above and, as such, may include a number of pixel emitters, pixel driver circuits, electrical rails, and so forth. More particularly, display assembly 650 may incorporate or make use of a set of electrical rails including a ground rail configured to provide a ground voltage, a first voltage rail configured to provide a first voltage greater than the ground voltage, and a second voltage rail configured to provide a second voltage greater than the first voltage. These rails may be generated by display assembly 650 in certain examples for use only by display assembly 650, or, in other examples, may be provided by device 660 and shared with other elements of the device. In any case, display assembly 650 may further include, as has been illustrated and described, a particular pixel driver circuit configured to drive a particular pixel emitter. The pixel driver circuit may include an electronic component having a ground terminal and a power terminal, the ground terminal being electrically coupled to the first voltage rail and the power terminal being electrically coupled to the second voltage rail.

Along with electric battery 662 and display assembly 650, device 660 is shown to include a processor 664 (implemented as any combination of general- and/or special-purpose processors or processing resources), a memory 666 (implemented as transitory memory and/or non-transitory storage resources), and other electronic components 668 as may serve a particular implementation. Each of these elements may also receive power from electric battery 662 and may interface with display assembly 650 in any suitable way to achieve the desired device functionality. In some examples, certain functions of display controller circuits described herein may be performed by processor 664 and memory 666 rather than by specialized circuitry onboard display assembly 650.

Various methods and processes performed by display assembly 650 (e.g., by display controller circuit 556) and/or by device 660 (e.g., by processor 664) may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

FIG. 7 shows an illustrative computing system 770 that may be used to implement various devices and/or systems described herein. For example, computing system 770 may include or implement (or partially implement) devices such as device 660 or any of the elements include therein (e.g., display assembly 650, etc.), any implementations thereof, and/or any devices used therewith.

As shown in FIG. 7, computing system 770 may include a communication interface 772, a processor 774, a storage device 776, and an input/output (I/O) module 778 communicatively connected via a communication infrastructure 780. While an illustrative computing system 770 is shown in FIG. 7, the components illustrated in FIG. 7 are not intended to be limiting. Additional or alternative components may be used in other embodiments. Components of computing system 770 shown in FIG. 7 will now be described in additional detail.

Communication interface 772 may be configured to communicate with one or more computing devices. Examples of communication interface 772 include, without limitation, a wired network interface (such as a network interface card), a wireless network interface (such as a wireless network interface card), a modem, an audio/video connection, and any other suitable interface.

Processor 774 generally represents any type or form of processing unit capable of processing data or interpreting, executing, and/or directing execution of one or more of the instructions, processes, and/or operations described herein. Processor 774 may direct execution of operations in accordance with one or more applications 782 or other computer-executable instructions such as may be stored in storage device 776 or another computer-readable medium.

Storage device 776 may include one or more data storage media, devices, or configurations and may employ any type, form, and combination of data storage media and/or device. For example, storage device 776 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 776. For example, data representative of one or more executable applications 782 configured to direct processor 774 to perform any of the operations described herein may be stored within storage device 776. In some examples, data may be arranged in one or more databases residing within storage device 776.

I/O module 778 may include one or more I/O modules configured to receive user input and provide user output. One or more I/O modules may be used to receive input for a single virtual experience. I/O module 778 may include any hardware, firmware, software, or combination thereof supportive of input and output capabilities. For example, I/O module 778 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 778 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 778 is configured to provide graphical data to a display for presentation to a user. The graphical data may be representative of one or more graphical user interfaces and/or any other graphical content as may serve a particular implementation.

The following examples describe implementations of power-saving signal buffers for pixel driver circuits in accordance with principles described herein.

Example 1: A pixel driver circuit including: a first voltage rail configured to provide a first voltage, the first voltage being greater than a ground voltage provided by a ground rail; a second voltage rail configured to provide a second voltage, the second voltage being greater than the first voltage provided by the first voltage rail; and a signal buffer having a ground terminal and a power terminal, the ground terminal being electrically coupled to the first voltage rail and the power terminal being electrically coupled to the second voltage rail.

Example 2: The pixel driver circuit of any of the preceding examples, further comprising a current source and a switch network, the current source being configured, when the switch network is in a particular state, to cause a pixel emitter electrically coupled to the pixel driver circuit to emit light.

Example 3: The pixel driver circuit of any of the preceding examples, wherein: the switch network includes a first switch and a second switch electrically coupled in series between the current source and the pixel emitter; the first switch is configured as a global pulse-width modulation (PWM) switch controlled by the signal buffer based on a global PWM signal provided to the pixel driver circuit and a plurality of other pixel driver circuits; and the second switch is configured as a local PWM switch controlled by a memory circuit configured to store a local PWM signal customized for the pixel driver circuit and not shared by the plurality of other pixel driver circuits.

Example 4: The pixel driver circuit of any of the preceding examples, wherein: the global PWM signal toggles at a first average frequency; the local PWM signal toggles at a second average frequency; and the first average frequency is at least double the second average frequency.

Example 5: The pixel driver circuit of any of the preceding examples, wherein: the signal buffer is an inverting buffer; and the global PWM switch and the local PWM switch are each implemented by P-type metal-oxide-semiconductor (PMOS) transistors.

Example 6: The pixel driver circuit of any of the preceding examples, wherein the pixel emitter is implemented as a micro light emitting diode (microLED).

Example 7: The pixel driver circuit of any of the preceding examples, wherein: the ground terminal is a first ground terminal and the power terminal is a first power terminal; the pixel driver circuit interoperates with additional circuitry within a display assembly; and at least one electronic component within the additional circuitry has a second ground terminal and a second power terminal, the second ground terminal being electrically coupled to the ground rail and the second power terminal being electrically coupled to the first voltage rail.

Example 8: The pixel driver circuit of any of the preceding examples, further comprising a selector circuit configured to selectively couple either the first voltage rail or the ground rail to the ground terminal of the signal buffer; wherein the pixel driver circuit is configured to operate in either: a low-power mode in which the selector circuit couples the ground terminal to the first voltage rail while the power terminal is coupled to the second voltage rail, or a full-power mode in which the selector circuit couples the ground terminal to the ground rail while the power terminal is coupled to the second voltage rail.

Example 9: The pixel driver circuit of any of the preceding examples, wherein the signal buffer further has a signal input terminal, the signal input terminal being configured to be electrically coupled to a global pulse-width modulation (PWM) signal generator.

Example 10: A display assembly comprising: a plurality of pixel emitters; a display controller circuit; a plurality of pixel driver circuits configured to drive, based on signaling received from the display controller circuit, the plurality of pixel emitters; a set of electrical rails including a ground rail configured to provide a ground voltage, a first voltage rail configured to provide a first voltage greater than the ground voltage, and a second voltage rail configured to provide a second voltage greater than the first voltage; and a signal buffer included within a pixel driver circuit of the plurality of pixel driver circuits, the signal buffer having a ground terminal electrically coupled to the first voltage rail and having a power terminal electrically coupled to the second voltage rail.

Example 11: The display assembly of any of the preceding examples, further comprising a current source and a switch network included within the pixel driver circuit, the current source being configured, when the switch network is in a particular state, to cause a pixel emitter of the plurality of pixel emitters to emit light.

Example 12: The display assembly of any of the preceding examples, wherein: the switch network includes a first switch and a second switch electrically coupled in series between the current source and the pixel emitter; the first switch is configured as a global pulse-width modulation (PWM) switch controlled by the signal buffer based on a global PWM signal provided to the plurality of pixel driver circuits; and the second switch is configured as a local PWM switch controlled by a memory circuit configured to store a local PWM signal customized for the pixel driver circuit and not shared by the plurality of pixel driver circuits.

Example 13: The display assembly of any of the preceding examples, wherein: the global PWM signal toggles at a first average frequency; the local PWM signal toggles at a second average frequency; and the first average frequency is at least double the second average frequency.

Example 14: The display assembly of any of the preceding examples, wherein: the signal buffer is an inverting buffer; and the global PWM switch and the local PWM switch are each implemented by P-type metal-oxide-semiconductor (PMOS) transistors.

Example 15: The display assembly of any of the preceding examples, wherein the plurality of pixel emitters is implemented as a plurality of micro light emitting diodes (microLEDs).

Example 16: The display assembly of any of the preceding examples, wherein: the ground terminal is a first ground terminal and the power terminal is a first power terminal; and the display assembly further comprises an additional electronic component having a second ground terminal and a second power terminal, the second ground terminal being electrically coupled to the ground rail and the second power terminal being electrically coupled to the first voltage rail.

Example 17: The display assembly of any of the preceding examples, further comprising a selector circuit included within the pixel driver circuit of the plurality of pixel driver circuits, the selector circuit being configured to selectively couple either the first voltage rail or the ground rail to the ground terminal of the signal buffer; wherein the pixel driver circuit is configured to operate in either: a low-power mode in which the selector circuit couples the ground terminal to the first voltage rail while the power terminal is coupled to the second voltage rail, or a full-power mode in which the selector circuit couples the ground terminal to the ground rail while the power terminal is coupled to the second voltage rail.

Example 18: The display assembly of any of the preceding examples, wherein the signal buffer further has a signal input terminal, the signal input terminal being configured to be electrically coupled to a global pulse-width modulation (PWM) signal generator.

Example 19: A device comprising: an electric battery; and a display assembly configured to be powered by the electric battery, the display assembly including: a pixel emitter; a set of electrical rails including a ground rail configured to provide a ground voltage, a first voltage rail configured to provide a first voltage greater than the ground voltage, and a second voltage rail configured to provide a second voltage greater than the first voltage; and a pixel driver circuit configured to drive the pixel emitter, the pixel driver circuit including a signal buffer having a ground terminal and a power terminal, the ground terminal being electrically coupled to the first voltage rail and the power terminal being electrically coupled to the second voltage rail.

Example 20: The device of any of the preceding examples, wherein the display assembly further includes a selector circuit configured to selectively couple either the first voltage rail or the ground rail to the ground terminal of the signal buffer; wherein the pixel driver circuit is configured to operate in either: a low-power mode in which the selector circuit couples the ground terminal to the first voltage rail while the power terminal is coupled to the second voltage rail, or a full-power mode in which the selector circuit couples the ground terminal to the ground rail while the power terminal is coupled to the second voltage rail.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

1. A pixel driver circuit including:
a first voltage rail configured to provide a first voltage, the first voltage being greater than a ground voltage provided by a ground rail;
a second voltage rail configured to provide a second voltage, the second voltage being greater than the first voltage provided by the first voltage rail; and
a signal buffer having a ground terminal and a power terminal, the ground terminal being electrically coupled to the first voltage rail and the power terminal being electrically coupled to the second voltage rail.

2. The pixel driver circuit of claim 1, further comprising a current source and a switch network, the current source being configured, when the switch network is in a particular state, to cause a pixel emitter electrically coupled to the pixel driver circuit to emit light.

3. The pixel driver circuit of claim 2, wherein:
the switch network includes a first switch and a second switch electrically coupled in series between the current source and the pixel emitter;
the first switch is configured as a global pulse-width modulation (PWM) switch controlled by the signal buffer based on a global PWM signal provided to the pixel driver circuit and a plurality of other pixel driver circuits; and
the second switch is configured as a local PWM switch controlled by a memory circuit configured to store a local PWM signal customized for the pixel driver circuit and not shared by the plurality of other pixel driver circuits.

4. The pixel driver circuit of claim 3, wherein:
the global PWM signal toggles at a first average frequency;
the local PWM signal toggles at a second average frequency; and
the first average frequency is at least double the second average frequency.

5. The pixel driver circuit of claim 3, wherein:
the signal buffer is an inverting buffer; and
the global PWM switch and the local PWM switch are each implemented by P-type metal-oxide-semiconductor (PMOS) transistors.

6. The pixel driver circuit of claim 2, wherein the pixel emitter is implemented as a micro light emitting diode (microLED).

7. The pixel driver circuit of claim 1, wherein:
the ground terminal is a first ground terminal and the power terminal is a first power terminal;
the pixel driver circuit interoperates with additional circuitry within a display assembly; and
at least one electronic component within the additional circuitry has a second ground terminal and a second power terminal, the second ground terminal being electrically coupled to the ground rail and the second power terminal being electrically coupled to the first voltage rail.

8. The pixel driver circuit of claim 1, further comprising a selector circuit configured to selectively couple either the first voltage rail or the ground rail to the ground terminal of the signal buffer;
wherein the pixel driver circuit is configured to operate in either:
a low-power mode in which the selector circuit couples the ground terminal to the first voltage rail while the power terminal is coupled to the second voltage rail, or
a full-power mode in which the selector circuit couples the ground terminal to the ground rail while the power terminal is coupled to the second voltage rail.

9. The pixel driver circuit of claim 1, wherein the signal buffer further has a signal input terminal, the signal input terminal being configured to be electrically coupled to a global pulse-width modulation (PWM) signal generator.

10. A display assembly comprising:
a plurality of pixel emitters;
a display controller circuit;
a plurality of pixel driver circuits configured to drive, based on signaling received from the display controller circuit, the plurality of pixel emitters;
a set of electrical rails including a ground rail configured to provide a ground voltage, a first voltage rail configured to provide a first voltage greater than the ground voltage, and a second voltage rail configured to provide a second voltage greater than the first voltage; and
a signal buffer included within a pixel driver circuit of the plurality of pixel driver circuits, the signal buffer having a ground terminal electrically coupled to the first voltage rail and having a power terminal electrically coupled to the second voltage rail.

11. The display assembly of claim 10, further comprising a current source and a switch network included within the pixel driver circuit, the current source being configured, when the switch network is in a particular state, to cause a pixel emitter of the plurality of pixel emitters to emit light.

12. The display assembly of claim 11, wherein:
the switch network includes a first switch and a second switch electrically coupled in series between the current source and the pixel emitter;
the first switch is configured as a global pulse-width modulation (PWM) switch controlled by the signal buffer based on a global PWM signal provided to the plurality of pixel driver circuits; and
the second switch is configured as a local PWM switch controlled by a memory circuit configured to store a local PWM signal customized for the pixel driver circuit and not shared by the plurality of pixel driver circuits.

13. The display assembly of claim 12, wherein:
the global PWM signal toggles at a first average frequency;
the local PWM signal toggles at a second average frequency; and
the first average frequency is at least double the second average frequency.

14. The display assembly of claim 12, wherein:
the signal buffer is an inverting buffer; and
the global PWM switch and the local PWM switch are each implemented by P-type metal-oxide-semiconductor (PMOS) transistors.

15. The display assembly of claim 10, wherein the plurality of pixel emitters is implemented as a plurality of micro light emitting diodes (microLEDs).

16. The display assembly of claim 10, wherein:
the ground terminal is a first ground terminal and the power terminal is a first power terminal; and
the display assembly further comprises an additional electronic component having a second ground terminal and a second power terminal, the second ground terminal being electrically coupled to the ground rail and the second power terminal being electrically coupled to the first voltage rail.

17. The display assembly of claim 10, further comprising a selector circuit included within the pixel driver circuit of the plurality of pixel driver circuits, the selector circuit being configured to selectively couple either the first voltage rail or the ground rail to the ground terminal of the signal buffer;
wherein the pixel driver circuit is configured to operate in either:
a low-power mode in which the selector circuit couples the ground terminal to the first voltage rail while the power terminal is coupled to the second voltage rail, or
a full-power mode in which the selector circuit couples the ground terminal to the ground rail while the power terminal is coupled to the second voltage rail.

18. The display assembly of claim 10, wherein the signal buffer further has a signal input terminal, the signal input terminal being configured to be electrically coupled to a global pulse-width modulation (PWM) signal generator.

19. A device comprising:
an electric battery; and
a display assembly configured to be powered by the electric battery, the display assembly including:
a pixel emitter;
a set of electrical rails including a ground rail configured to provide a ground voltage, a first voltage rail configured to provide a first voltage greater than the ground voltage, and a second voltage rail configured to provide a second voltage greater than the first voltage; and
a pixel driver circuit configured to drive the pixel emitter, the pixel driver circuit including a signal buffer having a ground terminal and a power terminal, the ground terminal being electrically coupled to the first voltage rail and the power terminal being electrically coupled to the second voltage rail.

20. The device of claim 19, wherein the display assembly further includes a selector circuit configured to selectively couple either the first voltage rail or the ground rail to the ground terminal of the signal buffer;
wherein the pixel driver circuit is configured to operate in either:
a low-power mode in which the selector circuit couples the ground terminal to the first voltage rail while the power terminal is coupled to the second voltage rail, or
a full-power mode in which the selector circuit couples the ground terminal to the ground rail while the power terminal is coupled to the second voltage rail.
